(19) United States
(12) Patent Application Publication
(10) Pub. No.: US 2003/0041501 A1
(43) Pub. Date: Mar. 6, 2003

(54) Fish finder

(76) Inventor: James Solon Barrett, Evansville, IN (US)

Correspondence Address: James Solon Barrett, 316 S. E. Second Street, Evansville, IN, 47713, US

(21) Appl. No.: 10/101,156

(22) Filed: Mar. 20, 2002

Related U.S. Application Data
(60) Provisional application No. 60/296,108, filed on Jun. 7, 2001.

(51) Int. Cl. A01K 1/00

(52) U.S. Cl. 43/4

(57) ABSTRACT

This invention, “The Fish Finder”, is a stick with a line for the water level marked by a plastic tie and which is painted green at the top, red in the middle, and white at the bottom. When the stick is driven into the lake or river up to the water level the day before, the fisherman can check the stick the next day to see if the water level has risen or dropped. If it is in the green area at the top of the stick, the water level has risen, and the fish will be biting; if the water level is in the red area, the water level has dropped, and the fish will not be biting. Attached to the plastic tie at the water level mark, is a paper fish with directions printed on it which is laminated; the fish is attached to the wooden gauge by inserting the plastic tie through the fish eye cut in the paper fish and then stapling the fish to the plastic tie.

### b. CROSS-REFERENCE TO RELATED APPLICATIONS

Solon's Fish Stick, Provisional Patent No. 60/296,108

### c. STATEMENT REGARDING FEDERALLY SPONSORED RESEARCH OR DEVELOPMENT

Not Applicable

### d. REFERENCE TO A MICROFICHE APPENDIX

Not Applicable

### e. BACKGROUND OF THE INVENTION

This invention relates to a gauge for determining whether fish are biting. It measures the water level of a lake or river which is an indicator of when fish are biting.

### f. BRIEF SUMMARY OF THE INVENTION

This invention is a water level gauge made of wood which is to be used by fishermen for the purpose of determining when the water level is high or low which will determine whether fish are biting.

### g. BRIEF DESCRIPTION OF THE SEVERAL VIEWS OF THE DRAWING

FIG. 1 is a perspective top view of the wooden gauge;

FIG. 2 is a side view of the wooden gauge;

FIG. 3 is a drawing of the directions tag in the shape of a fish which accompanies the invention and is attached to the plastic tie by inserting the tie into the hole in the fish and then stapling the fish to the plastic tie.

### h. DETAILED DESCRIPTION OF THE INVENTION

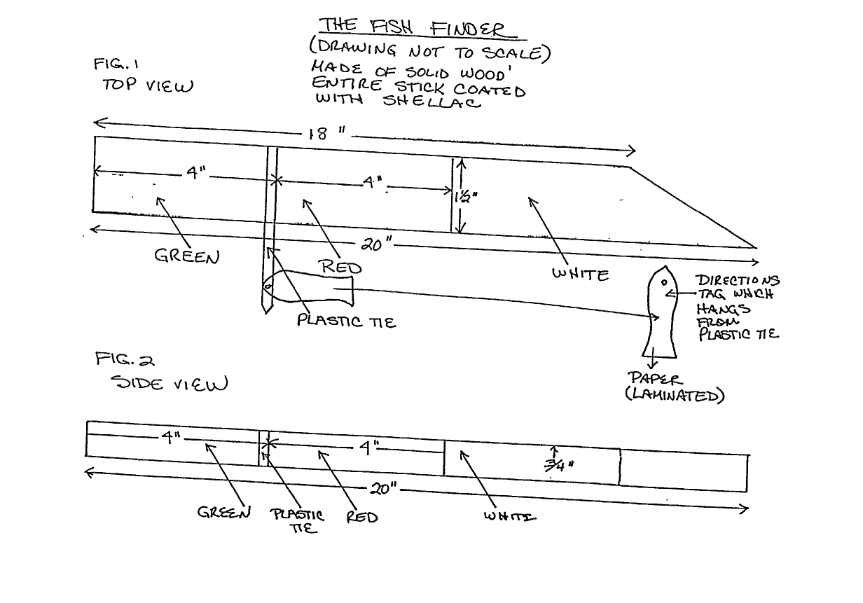

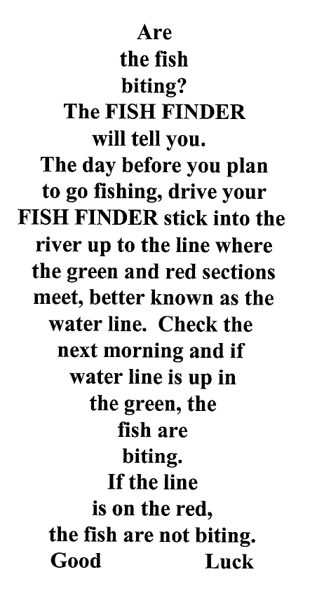

Referring to FIGS. 1 and 2, this invention is a stick with a line for the water level marked and which is painted green at the top, red in the middle, and white at the bottom. When the stick is driven into the lake or river up to the water level the day before, the fisherman can check the stick the next day to see if the water level has risen or dropped. If it is in the green area at the top of the stick, the water level has risen, and the fish will be biting; if the water level is in the red area, the water level has dropped, and the fish will not be biting.

While there has been shown and described a preferred embodiment of the gauge to measure water level for the purpose of determining if fish are biting, it is understood that changes in structure, materials, sizes, and shapes can be made by those skilled in the art without departing from the invention. The invention is defined in the following claims:

Referring to FIG. 3, there is a paper fish with directions printed on it which is laminated; the fish is attached to the wooden gauge by inserting the plastic tie through the fish eye cut in the paper fish and then stapling the fish to the plastic tie.

1. I claim that no one has invented or distributed a fisherman's tool such as this to determine if fish are biting. What I claim as my invention is a stick which will tell a fisherman when the fish are biting as follows:
the fisherman can drive the stick into the lake or river and use the stick to gauge the water level which will tell him or her if the fish are biting, i.e., when the level is in the green area of the stick, they are biting, and when it is in the red area of the stick, they are not.
